(19) United States
(12) Patent Application Publication
(10) Pub. No.: US 2022/0343409 A1
(43) Pub. Date: Oct. 27, 2022

(54) OPENMALL PROCESS AND METHOD OF SOCIAL COMMERCE USING ARTIFICIAL INTELLIGENCE

(71) Applicant: OPENAI S.R.L., Monza (IT)

(72) Inventor: Gennaro CALI', Milano (IT)

(21) Appl. No.: 17/754,257

(22) PCT Filed: May 22, 2020
(86) PCT No.: PCT/IT2020/000045

§ 371 Date: Mar. 29, 2022

(51) Int. Cl. G06Q 30/06; G06Q 50/00

(52) U.S. Cl. CPC G06Q 30/0643; G06Q 50/01

(57) ABSTRACT

The Openmall method, operating for PCs, tablets and/or smartphones or any other device, which provides help to users through 3D virtual assistants equipped with artificial intelligence and, therefore, avatars, for the purchase and/or sale of goods and services within a Mall, in virtual trade shows, unlimited to other types of virtual spaces. Virtual interaction with other users can also occur unlimitedly with the avatars themselves by means of artificial intelligence with neural network. Avatars can then also access and/or share business-intelligence information and then provide this information to real users, or between avatars themselves. The Openmall method through virtual avatars equipped with artificial intelligence simulates the ways in which the human mind draws logical conclusions through reasoning, making the avatars themselves capable of interacting with each other. The method has internal services such as e-commerce, social networks, logistics and/or payments that can also be made with virtual currency, profit sharing, audio streaming, video, etc., possibly specific depending on the immersive virtual environment adopted as a digital replica of the reality.

The method thus facilitates collaboration between man and machine, guaranteeing companies growth and competitive advantages.

### BACKGROUND OF THE INVENTION

The “OpenMall” method is a process to improve the digital marketplace driven by artificial intelligence, tailored to users' needs to improve the shopping experience in a virtual shopping centre, 3D virtual trade shows or another type of virtual setting.

The Openmall method allows users in general, be they buyers or retailers within a virtual shop, to make it easier for them to make purchasing decisions or vice versa when retailing products within the Mall itself.

The “Open Mall” method is a particularly high-performance process operating on 5G and higher technology and with high-speed connections. 5G technology enables the “Open Mall” method to carry out the computational part in the MEC device (multi-edge computing with specific dedicated processors) installed in the repeaters, substantially lightening (if not completely eliminating) the computational part on mobile devices (smartphones, tablets, etc.).

The method facilitates collaboration between man and machine to ensure the success of companies in terms of growth, well-being and competitive advantage. The OpenMall method and/or procedure is implemented starting from a plan or real “Mall”. The 360° experience of those who enter shopping centres every day is replicated digitally. Inside the Mall, users will not only find shops, but also squares, fountains and all the components that recreate a physical commercial environment that is a 3D virtual trade show or other, through its digital reconstruction. The Mall community has the possibility of virtually browsing the digital space of the Mall and sharing its experience with other people through a dedicated social network and live chat platform. You can also virtually visit the shop windows, take advantage of promotions and interact with a virtual shop assistant (avatar) to receive information, suggestions and to buy goods directly online.

The “OpenMall” method is therefore a union between artificial intelligence and social commerce in an immersive virtual reality.

The “OpenMall” method is a new shopping experience that offers services to a social community network through collective purchasing, a shopping experience shared with friends or strangers (new users), who immerse themselves in the same environment where they can use more services. The “OpenMall” method is a system that will provide a 360° innovative shopping experience, combining online shopping with the value of customised assistance and the pleasure of real-time interaction thanks to the live chat function, which enables users to interact with the social community. The virtual individual shop assistants, in the interaction with consumers, are connected to the central OpenMall database from which they acquire important information about the customer, promoting customer satisfaction and cross-selling. It should be noted that the technologies used, such as chat bots, big data analysis, neural networks and artificial intelligence, are extremely innovative and offer a 3D platform that interacts with thousands of shops ready to open their doors to the shopping community of millions of users.

The “OpenMall” method puts the customer/user at the centre of its vision, thanks to the profiling system, which involves collecting user data and then dividing users into groups of behaviour and/or other similarity criteria. The advanced algorithms used by the platform are capable of monitoring the Customer Journey and saving preferences in the Mall database managed by a central Artificial Intelligence ecosystem. Each user's personal shopper will be able to communicate customised proposals and promotions based on the products and services displayed or purchased and thanks to the comments and shares exchanged in the community. The platform integrates an intelligent conversational system with which the virtual assistants present in the Mall understand and process natural language using the Natural Language Processing technique.

To do this, we use learning machine solutions that are trained to understand users' intentions to provide support, assistance and product suggestions and that are capable of updating the status of the conversation in accordance with those intentions.

### SUMMARY OF THE INVENTION

The primary goal of the OpenMall project is to make users' experience of social commerce accessible primarily by mobile. Therefore, the choice was to create an entirely web-based solution for OpenMall. A webapp that offers a series of advantages in terms of the extent of devices that can use it (mobile, smartphone, PC, tablet, smart TV, tablet, interactive media station, etc.) as well as in terms of speed and rapidity of interaction with users, to the possibility with specific software, coexistence of VT360 (Virtual Tour 360) and 3D and VR and AR on the same device according to the customer's choice.

OpenMall users will have the option to register, profile and access their personal panel, where they will have a series of information and services at their disposal and from which, in line with future releases, they will be able to start their experience in VT360 mode, in 3D mode, in VR and AR mode where provided for or activated by the store. In the future, users will be able to configure their avatar to move around the Mall and interact with other users and configure their personal artificial intelligence assistant (MyAi) that can be trained for other personal purposes (assistance, work, entertainment, etc.). The virtual assistant (avatar), equipped with artificial intelligence, proposes and reports, at real users' request, the offers and/or services that it detects in the Mall's social community or in virtual trade shows, or in virtual spaces, so that it can decide on its possible purchases or use of specific services and/or applications. Users also have a Live Chat to dialogue and interact with other users, in addition to having their own electronic wallet in Mall currency, which can be spent and converted in various ways. They also have access to various loyalty and gaming systems and general services (streaming, banking, cinema, insurance, tourism, payments, etc.). Unlimitedly, currency may be connected to tokens and blockchain, profit sharing systems, etc. Thanks to the Openmall method, users may also decide not to use the virtual assistant and buy autonomously in the social community. The virtual assistant (avatar) equipped with artificial intelligence can propose and report, to users, all the opportunities and offers in the social community, virtual trade shows or virtual spaces.

In fact, a cashback system on purchases made or on the basis of other dynamics and profit-sharing algorithms at various levels amongst all users of the service is envisaged for this purpose.

In the Mall, it will also be possible to manage a series of communication and digital ADV activities with which shops or service companies can increase the degree of engagement with end users. There is also a series of specific services that are unrelated to commercial activities, such as e-learning with the support of artificial intelligence and room rental, in which one or more users, through their avatars, can perform specific activities such as training, business meetings or daily work activities, breaking down time and space limits and/or even replicating, in VR, real physical or virtual co-working spaces.

The scenic skeleton of the Mall, as we said, may be possibly identical to a physical Mall. Therefore, it will have a predefined structure or structure under construction and then based on a plan provided by the customer (e.g., real estate) when customised projects are required. OpenMall, on the other hand, will have its own proprietary architecture and a modular, mixed and integrated specificity according to the needs and choices of the shops that enter the platform.

The possible technological steps of OpenMall are therefore:
360 tour of OpenMall and the shops
3D (of OpenMall or of the physical space in case of replication of the real) and VR immersive in the 3D created
AR in the physical space if required and reality mixed in the web Mall.

360 Tour of OpenMall and of the Shops.

Users will be able to move in this mode inside the Mall and enter the various shops as if they were really doing so.

Users can therefore find themselves in front of the virtual shop entrance spontaneously and, in this case, by clicking on the sign of any virtual shop, enter it and, accompanied by the Mall's artificial intelligence (i.e. the avatar), directly visit the shop. In both cases, users are greeted by the AI personal shopper specific to that shop.

Through specific technology, OpenMall is fully virtualised in 3D, enabling an experience from any device (including mobile), either in direct mode or in VR mode with a viewer. This solution, like a 3D game, also allows for a strong dynamism of both the user and the other connected users, with the possibility of a strong interaction, i.e., users can talk (in VR as if users were physically facing each other), meet in some specific areas of the Mall, share offers and promotions, exchange coins and promotions, watch a film together, etc. The total immersive experience is enriched by the possibility of having, in addition to users, also assistants of the various shops to interact with in 3D and, especially, in virtual and mixed reality. For this purpose, in fact, the Openmall method, being an immersive virtual reality social commerce with real users and/or virtual avatars equipped with artificial intelligence is equipped and, therefore, has neural networks for the implementation of said method.

The OpenMall design will be based on a modular architecture that will make the entire system maintainable and scalable and allow for the future expansion of features without structural interventions. This architecture will be based on an approach to micro-services communicating with each other through REST APIs, each dedicated to providing a specific service.

The analysis of the general features suggest that the design of the entire system is to be divided into three parts, identified as subsystems, each dedicated to the management of the features of the three key players foreseen in OpenMall: shopkeepers (and service companies in a similar manner), consumer users and the Mall.

Shopkeepers will have a dedicated area through which they can configure their virtual shop. The set of services that manage all the features dedicated to the shop area compose what we identify as the “Virtual Shop” subsystem. This subsystem will initially consist of three main characteristics:
Product catalogue
3D Store
Conversational agent (workbot)

The modular structure of the “Virtual Shop” subsystem will allow for the expansion of the characteristics and features of the shop through the creation of new services and the recording of the latter in said subsystem. The configuration information is stored in the central system database to which each individual service has access.

The other key player in the system is the consumer, i.e., the OpenMall member who visits the mall looking for a good to buy.

The usage scenario in this case foresees that the consumer interacts, in the first instance, with the Mall's workbot, which will try to identify the consumer's needs and guide him/her to the OpenMall shop that best meets his/her needs. The user management features will be provided by the “User Management” subsystem, in which each member can configure their profile, store their preferences (including any mall shops) and manage their purchases.

The “User Management” subsystem includes a profiling module dedicated to the collection of user behaviour data which will be used by the suggestion system to propose advertisements and offers deemed to be of interest to the consumer. The profiling of user data involves the collection and processing of data relating to the users of the services in order to divide the users into groups of behaviour and/or other criteria of similarity.

Lastly, the “Mall” subsystem is responsible for creating the general environment for the operation of the system, for implementing all of the connection features between the user and the virtual shops present in the system and for providing the interfaces (APIs) to internal services (possibly also external CRM ERP etc.) and, more generally, for managing and coordinating the various activities required by the workflow. This includes, for example, the mall workbot (or central AI), the data storage module (database), the module for behaviour analysis and suggestion. The Mall subsystem also includes the UI with which users interface with OpenMall, both in terms of web portal and, much more importantly, in terms of the virtual mall assistant that guides the consumer in the virtual mall in search of the products they need. The “mall” subsystem then creates an interface layer that makes all the basic features available to the other modules and manages the information flow. This layer also allows for the future addition of new services without the need for heavy intervention on the entire system.

Within the subsystem, a series of modules dedicated to the various basic features exposed are foreseen.

Such as, for example:
The “Data Mining and Suggestion” module
The “User Clustering” Module
The “Workbot Engine” Module
The MyAi module.
The “Business Intelligence” (BI) Module
The “Mixed Reality” Module
The “Services” Module
Storage

The “Data Mining and Suggestion” Module

This module implements and displays services for the analysis of data collected by the system. It incorporates Data Mining and Rule Discovery algorithms aimed at discovering hidden and recurring correlations between data and the ability to exploit these patterns as suggestions to users. The suggestion of items to be purchased based on previous purchases or similar behaviour to other users are some examples of features exposed by this module. This module, in fact, implements and exposes services for the analysis of data collected by the system, through the identification of associations, anomalies and recurring patterns between different sources of information and then within them.

The “User Clustering” Module

This module implements user clustering algorithms for similar characteristics. The output of the module therefore consists of groups of users who share interests, behaviours, tastes and any other characteristic used by the various algorithms to predict groupings and can be eventually used by other modules to perform their features: for example, it is plausible to imagine that the Data Mining module takes into account the cluster for the discovery of suggestions to be proposed to the user. The algorithms are implemented by grouping users by similar characteristics, with aggregations or selections of elements that have characteristics of homogeneity and similarity within a quantity of data.

The “Workbot” Module

The workbot module manages the conversational aspects of the system. Specifically, the module will consist of the conversational engine that manages both the general workbot of the mall and the workbots of the virtual shops. This module includes—with the addition of specific algorithms (e.g., inferential) that simulate how the human mind draws logical conclusions through reasoning—individual users' personal assistants. The workbot module manages the conversational aspects within the Openmall method through NLP (natural language processing), which analyses and understands human language. NLU is also involved in the understanding of machine reading and the categorisation of texts and content analysis. Lastly, via NLG, the system is able to make decisions on how to transform a concept and data into words.

Business Intelligence (BI)

This module, as its name suggests, contains the business intelligence features applicable to the data stored in the database. It will allow the system to provide graphs and monitoring dashboards related, for example, to the economic and financial data of the virtual shops, as well as other insights of the overall system. The BI module contains business intelligence features applied to the stored data both by connecting the artificial intelligence applications to the various databases with connectors, such as APIs, and by loading the database system in .xls or .csv format in order to generate statistics, reports and predictive analysis.

Mixed Reality Module

This is the module that is in charge of the Mall virtualisation in 3D and that, thanks to specific programming languages (e.g., A-Frame, AR.js, etc.) makes the immersive experience in VR and AR and XR accessible. ADV spaces and individual shops will also be managed by this module. This module, takes charge of the virtualisation of the mall in 3D, or virtual trade shows or other virtual spaces, with specific programming languages that make it usable in augmented or mixed reality via the web and on any existing or future devices, allowing for the use of the same services (e-commerce, social networks, streaming, etc.) and, specifically, through the coexistence of avatars of individuals and artificial intelligence virtual assistants capable of interacting.

MyAi Module

The MyAi module, i.e., the personal and customisable artificial intelligence virtual assistant, simulates the ways in which the human mind draws logical conclusions through reasoning, through an inferential engine that is capable of making decisions based on both basic knowledge and external information. The processed information initiates actions that are communicated to a user, becoming new knowledge for subsequent processing, thus making the system self-learning.

Services Module

OpenMall has, within it, a series of general services, such as payments, logistics, streaming, internal and external digital marketing, gamification systems, loyalty, security, smart contract, virtual currency and profit sharing, etc., some of which are also managed through blockchain and token technology, representing the sub-modules within this service module.

Storage

This module will provide data storage services to the entire system. It therefore incorporates all types of data storage services:
structural data (database)
non-structural data (no-sql engine)

As a conversation engine for the management of the mall workbot and virtual shop workbots, it will be implemented using AI+, one of the most modern and powerful systems for the creation and management of conversational agents. This engine enables users to configure, in a simple and intuitive manner, a conversational agent capable of communicating effectively on a specific knowledge base. It also provides a set of tools that enable easy integration with external services and, thus, the exploitation of existing data and information on third-party databases.

A fair amount of hardware (HW) resources are required to set up the system. Given the strong requirement of both horizontal and vertical scalability required by the project, it is necessary to provide flexible approaches, which enable the allocated resources to be increased in a streamlined manner. It is also necessary to implement a system capable of meeting the highest standards in terms of business continuity and disaster recovery, which means an additional need for resources to ensure the necessary redundancy of data and services.

The interactive platform of the Openmall method is equipped with virtual avatars that are instructed according to two important steps:
a) the data is entered into the platform by real users through messages, chats and/or texts that are fragmented and broken up into one or more tokens, which, through lemmatization and other computational linguistics operations, instruct the machine.
b) Once the machine has been instructed, as in phase a), a neural network structures the data received with analyses based on statistical calculation algorithms that enable the machine and, therefore, the virtual assistants, to self-learn and self-train.

The general architecture of the Invention in question is based, but not limited to, the following main technical characteristics:
a) Possibility of using SQL databases (Microsoft SQL, Postgre SQL, Oracle SQL, etc.), NoSQL (MongoDB, OrientDB, XML, etc.), and mixed databases (MySQL, MariaDB).
b) Server-side programming languages: Python, Javascript, PHP, Java, AR.js, A-Frame and OpenXR
c) Source code development and version control environments
d) Mobile Client: Apple Ios, Google Android, Huawei's Harmony OS.
   Any other mobile device that has a browser application.
e) Mobile programming languages: Java, Javascript
f) Development environments (framework): given the various specific features listed, various frameworks are used, for deep learning in python Keras, which interact with any type of database, without limiting, in this way, interactions with the various management programmes, project management programs, etc. The following Python libraries are used for NLP processes; NLTK, TextBlob, CoreNLP, spaCy, gensim. Machine learning libraries and neural networks used for Javascript are as follows: brain.js, Synaptic, Neataptic, TensorFlow.js, on framework Node.js. As an advanced editor to manage the interfaces, Microsoft's Visual Studio Code is then used.

All methods and functions are made public, including user authentication, reading and writing of data useful for the full operation of the system.

The logics and rules of the system are mostly written using the framework. Net Core C # (MVC5, Entity Framework and LinQ) and implementing database-side procedures and functions (SQL.Server.TL/SQL).

In the VR, AR and XR area, A-Frame and AR.js are favoured to facilitate mobile and Javascript integration. However, future developments are seen in the OpenXR framework.

Customer requests are made through the interface between the server system and the services requested by said customer. This guarantees immediate response and interaction, which can be perceived transparently by the end user using the client mobile application. In addition to the service, in essence as already explained, it is planned to provide a number of services deemed necessary to give maximum credibility to the service in clients' interest.

Specifically, they are expected:
a) Services to verify the identity of users
b) Clear and specific rules on safety and pricing transparency
c) Reputation system
d) Effective check on the correct use of the platform
e) Monitoring of users and their activities in the choice of services
f) Payment management and transaction monitoring
g) Insurance and guarantees as part of the transaction commissions
h) Definition of rules and tariffs
i) Complaints and refunds management.

The task and aims of this Invention are thus achieved both by Telematics and by physical means via software that process the data entered.

For the activation, the following will have to be provided:
Means functionally and operationally connected and controlled by programmable logical means
Means of visualisation or audio-visualisation
First and second memory media that can be updated in real time
Means of entering parameters and personal data
Means of selection
Means of interfacing with programmable logic control
Means to enable the customer and the administration of the platform to communicate in real time with the equipment.

Advantageously, at least all the aforementioned means are integrated into a single logical operating module configured as a PC, tablet, etc. by means of a programme which, when executed, will allow the equipment of the Invention to operate according to the phases of the method of said Invention.

This Invention is implemented according to an “OpenMall” method with a service suitable for PCs, smartphones, tablets, etc.

The operations necessary to understand that its form of implementation are not limited to the following categories and/or steps:
Openmall category step 1): customers enter the website by entering their personal data to register for the service
Openmall category step 2): customers choose the desired type of service. The server checks requirements and availability of information automatically and in real time. If, during this step, the requirements are not met or you access a new search, the system will either send customers a text message or an email when the requested services are available. If the requirements are met, the system will send customers a request to use the requested services.
Openmall category step 3): customers in this category will be able to purchase any additional services offered by the server via the application. It should be remembered that the system in question allows operators and the administration to view any changes to the services that users make.

The specific use of MEC (Multi-Access Edge Computing) on the 5G network processes various inputs differently.

The method and equipment of the Invention in question have been described with reference to forms of implementation currently preferred, improvable and obviously not limited, given that they are subject to a number modifications and variations, all within the scope of said Invention, therefore, rather than from the description the Invention finds its protective scope in line with the following claims.

1. Openmall process of immersive virtual reality social commerce including the phases of:
i) collection of user data;
ii) profiling of user data;
iii) creation of a social community, unlimited to virtual trade shows and virtual spaces based on user data;
iv) unlimited choice of purchase or sale service by users, in a social community in a mall or in 3D virtual trade shows, or in another type of virtual setting;
v) configuration and assignment of one or more virtual assistants—or avatar—to users and/or retailers, who interact in the social community, in virtual trade shows and not limited to other types of virtual space.
vi) search by virtual assistants for buying or selling services within social community stores, in trade shows or virtual spaces;
vii) feedback to users of search results and interactions and initiation of actions

2. The Openmall process of immersive virtual reality social commerce, according to claim 1, is characterised by the fact that the profiling of user data consists of collecting and processing data regarding the users of the services in order to divide the users into groups of behaviour and/or other criteria of similarity.

3. The Openmall process of immersive virtual reality social commerce, according to claim 1 is characterised by the fact that virtual assistants are equipped with artificial intelligence.

4. The Openmall process of immersive virtual reality social commerce, according to claim 1 is characterised by the fact that the choice of services by customers can take place according to the following steps:
a) the virtual assistant or avatar equipped with artificial intelligence proposes and reports, at the real user's request, the offers it detects in the social community, in virtual trade shows, or in virtual spaces, so that it can decide upon users' possible purchases.
b) Real users can also ask virtual assistants or avatars to make purchases not limited to the social community in virtual trade shows or virtual spaces.
c) Real users can also decide not to use virtual assistants and buy autonomously within the social community.

5. The Openmall method of immersive virtual reality social commerce, according to claim 1, is an interactive platform of real users and virtual avatars equipped with artificial intelligence, which are instructed to perform the steps of the previous claim according to the following steps:
a) The data entered by real users through messages, chats, and/or texts are fragmented and broken down into one or more tokens which, through lemmatization and other computational linguistics operations, instruct the machine.
b) Once the machine is instructed as in phase a), a neural network structures the data received with learning based on statistical calculation algorithms, which enable the machine and, therefore, the virtual assistants, to self-learn and selftrain.

6. The Openmall method of immersive virtual reality social commerce with real users and/or virtual avatars equipped with artificial intelligence, by means of neural networks is characterised by having neural networks—

7. The Openmall method of social commerce of immersive virtual reality, according to claim 6, with data mining and suggestion module, is characterised by the fact that it implements and exposes services for the analysis of data collected by the system, through the identification of associations, anomalies and recurring patterns between various sources of information and, therefore, within them.

8. The Openmall method of immersive virtual reality social commerce, according to claim 6 with user clustering module, is characterised by the fact that the implementation of the algorithms is carried out by grouping users for similar characteristics, through aggregations or selections of elements that have characteristics of homogeneity and similarity within a quantity of data.

9. The Openmall method of immersive virtual reality social commerce, according to claim 6 with the workbot module, is characterised by the fact that it manages the conversational aspects present in the system through the following steps:
(a) through NLP or (natural language processing), which enables the workbot or (evolved chatbot) to analyse and understand human language;
(b) through NLU (natural language understanding), which deals with machine reading comprehension, text categorisation and content analysis;
(c) through NLG (natural language generation), with which the system makes decisions on how to transform a concept and data into words.

10. The Openmall method of immersive virtual reality social commerce, according to claim 6 with the MyAi module (personal and customisable artificial intelligence virtual assistant) is characterised by the fact that it simulates the ways in which the human mind draws logical conclusions through reasoning, through an inferential engine that is capable of making decisions based on both basic knowledge and information from the external environment. The processed information initiates actions or is communicated to a user and becomes new knowledge for subsequent processing making the system selflearning.

11. The Openmall method of immersive virtual reality social commerce, according to claim 6, with the Business Intelligence (BI) module, is characterised by the fact that it contains the business intelligence features applied to the data stored in the database according to the following steps:
(a) by connecting artificial intelligence applications to the various databases using connectors such as A.P.I.;
(b) by loading the database system in .xls or .csv format to generate statistics, reports and predictive analysis.

12. The Openmall method of immersive virtual reality social commerce, according to claim 6 is characterised by the fact that the “web x-reality” module takes over the virtualisation of the mall in 3D, or virtual trade shows or other virtual spaces, with specific programming languages that makes it usable in augmented or mixed virtual reality via the web and on any existing or future device. It also enables, in virtual reality, the use of said services (e-commerce, social networks, streaming, etc.) and, specifically, through the coexistence of avatars of individuals and artificial intelligence virtual assistants that are capable of interacting.

13. The Openmall method of social commerce of immersive virtual reality, according to claim 6 is characterised by the fact that the services module has, within it, general services, such as logistics, and/or payments with virtual currency, profit sharing, audio and video streaming, etc.

14. The Openmall procedure, according to claim 6, comprises a modular architecture that makes the entire system maintainable and scalable and enables the future expansion of features without structural interventions.
